(19) United States
(12) Patent Application Publication
(10) Pub. No.: US 2021/0140771 A1
(43) Pub. Date: May 13, 2021

(54) APPARATUS FOR EVALUATING DEGREES OF CONTRIBUTION

(71) Applicant: TOYOTA JIDOSHA KABUSHIKI KAISHA, Toyota-shi (JP)

(72) Inventor: Ryo IGARASHI, Tokyo-to (JP)

(21) Appl. No.: 17/086,590

(22) Filed: Nov. 2, 2020

(30) Foreign Application Priority Data
Nov. 8, 2019 (JP) 2019-203412

(51) Int. Cl. G01C 21/28; G01C 21/34; G05D 1/02

(52) U.S. Cl. CPC G01C 21/28; G05D 1/0221; G05D 1/0285; G01C 21/3446

(57) ABSTRACT

The apparatus for evaluating degrees of contribution includes: a memory configured to store a plurality of maps including information on travel conditions of individual roads, an algorithm table indicating, for each of the maps, an algorithm used for generating or updating the map out of a plurality of algorithms each used for generating or updating at least any one of the maps, and a provider table indicating, for each of the algorithms, a provider who provides the algorithm; and a processor configured to determine frequencies of use of the algorithms, based on the algorithm table and the numbers of times of delivery of the maps in a predetermined period, and calculate a degree of contribution to generation or update of a map for each of the providers, based on the provider table and the frequencies of use of the algorithms.

### FIELD

The present invention relates to an apparatus for evaluating degrees of contribution to generation or update of maps.

### BACKGROUND

It is desired that highly accurate maps to which an automated vehicle-driving system refers to perform automated driving control of a vehicle should accurately represent information on road environment. To this end, it is preferred that information which indicates actual road environment and is used for generating or updating a map can be appropriately collected. For this reason, a technique has been proposed to appropriately give an incentive point in response to information being transmitted from a vehicle to a map update server (e.g., see Japanese Unexamined Patent Publication No. 2018-141842).

For example, Japanese Unexamined Patent Publication No. 2018-141842 discloses a technique to generate external environment information on the environment outside a vehicle in association with the location of the vehicle on a map, based on the location of the vehicle on the map and a detection result of a sensor mounted on the vehicle, and to give a predetermined incentive point to a user of the vehicle or the vehicle in accordance with a degree of map freshness of a region corresponding to the external environment information when the external environment information is transmitted from the vehicle to a map update server.

### SUMMARY

In order to generate or update maps, not only information on road environment but also various types of algorithms for generating or updating maps on the basis of such information are used. Accordingly, a mechanism for appropriately evaluating degrees of contribution of providers (also referred to as developers) who provide algorithms used for generating or updating maps is required.

It is an object of the present invention to provide an apparatus capable of evaluating degrees of contribution of providers who provide algorithms used for generating or updating maps.

According to an embodiment, an apparatus for evaluating degrees of contribution is provided. The apparatus includes: a memory configured to store a plurality of maps including information on travel conditions of individual roads, an algorithm table indicating, for each of the plurality of maps, an algorithm used for generating or updating the map out of a plurality of algorithms each used for generating or updating at least any one of the plurality of maps, and a provider table indicating, for each of the plurality of algorithms, a provider who provides the algorithm out of a plurality of providers; and a processor configured to determine frequencies of use of the plurality of algorithms, based on the algorithm table and the numbers of times of delivery of the plurality of maps in a predetermined period, and calculate a degree of contribution to generation or update of a map for each of the plurality of providers, based on the provider table and the frequencies of use of the plurality of algorithms.

In this case, the processor preferably assigns weights to the frequencies of use of the plurality of algorithms in accordance with types of the plurality of algorithms, and calculates the degree of contribution for each of the plurality of providers in accordance with the sum of weighted frequencies of use of algorithms provided by the provider.

For each of the plurality of providers, the processor preferably gives a higher incentive point to the provider as the degree of contribution of the provider increases.

In the apparatus, each of the plurality of maps is preferably assigned a degree of credibility of information on the travel conditions represented in the map. For each of the plurality of maps, the processor preferably assigns a higher degree of credibility to the map as the degree of contribution of a provider of an algorithm used for generating or updating the map increases.

The apparatus preferably further includes a communication device capable of communicating with a vehicle using any one of the plurality of maps to perform automated driving control. In this case, upon receiving information indicating that automated driving control cannot continue and information indicating a map in use out of the plurality of maps from the vehicle via the communication device, the processor preferably decreases the degree of contribution of a provider who provides an algorithm used for generating or updating the map out of the plurality of algorithms.

Alternatively, it is preferred in the apparatus that each of the plurality of maps represents the locations and types of terrestrial features imposing travel conditions of individual roads, and that the memory further store a reference map representing the locations and types of the terrestrial features. The processor preferably decreases the degree of contribution of a provider who provides an algorithm used for generating or updating any one of the plurality of maps out of the plurality of algorithms as a difference between the location and type of a terrestrial feature represented in the map and the location and type of a corresponding terrestrial feature represented in the reference map increases.

The apparatus according to the present invention has an advantageous effect of being capable of evaluating degrees of contribution of providers who provide algorithms used for generating or updating maps.

### BRIEF DESCRIPTION OF DRAWINGS

FIG. 1 schematically illustrates the configuration of a map delivering system including an apparatus for evaluating degrees of contribution.

FIG. 2 schematically illustrates the configuration of a vehicle.

FIG. 3 illustrates the hardware configuration of a server, which is an embodiment of the apparatus for evaluating degrees of contribution.

FIG. 4 is a functional block diagram of the processor of the server, relating to map delivery processing and contribution evaluating processing.

FIG. 5 illustrates an example of the relationship between providers, algorithms and maps.

FIG. 6 is an operation flowchart of the contribution evaluating processing.

### DESCRIPTION OF EMBODIMENTS

Hereinafter, with reference to the accompanying drawings, an apparatus for evaluating degrees of contribution will be described. The apparatus stores a plurality of maps, which may also be referred to as road maps, for the same region; the maps include information on travel conditions of individual roads included in the region, and are used for travel control of a vehicle. More specifically, each map represents the locations and types of terrestrial features (e.g., road markings, such as lane division lines, stop lines and speed signs, signposts or signal lights, etc.) imposing travel conditions of individual roads represented in the map. The apparatus can deliver each map to a plurality of vehicles. Further, the apparatus stores an algorithm table indicating, for each of the maps, one or more algorithms used for generating or updating the map (i.e., a correspondence between the maps and the algorithms), and a provider table indicating providers of the respective algorithms (i.e., a correspondence between the algorithms and the providers). Each of the vehicles can select and download any one of the maps in accordance with selection by a driver of the vehicle. The apparatus determines frequencies of use of the respective algorithms, based on the algorithm table and the numbers of times of delivery of the respective maps in a predetermined period, and calculates degrees of contribution to generation or update of the maps for the respective providers, based on the provider table and the frequencies of use of the respective algorithms.

FIG. 1 schematically illustrates the configuration of a map delivering system including an apparatus for evaluating degrees of contribution. In the present embodiment, the map delivering system 1 includes at least one vehicle 2 and a server 3, which is an example of the apparatus for evaluating degrees of contribution. The vehicle 2 accesses a wireless base station 5 connected, for example, via a gateway (not illustrated) or the like to a communication network 4 connected with the server 3, thereby connecting to the server 3 via the wireless base station 5 and the communication network 4. Although FIG. 1 illustrates only one vehicle 2, the map delivering system 1 may include a plurality of vehicles 2. Similarly, the communication network 4 may be connected with a plurality of wireless base stations 5.

FIG. 2 schematically illustrates the configuration of the vehicle 2. As illustrated in FIG. 2, the vehicle 2 includes a GPS receiver 11, a camera 12, a wireless communication terminal 13, a user interface 14, a storage device 15 and an electronic control unit (ECU) 16. The GPS receiver 11, the camera 12, the wireless communication terminal 13, the user interface 14 and the storage device 15 are connected to the ECU 16 so that they can communicate with each other via an in-vehicle network conforming to a standard, such as a controller area network. The vehicle 2 may further include a navigation device (not illustrated) for searching for a planned travel route from the current location to a destination of the vehicle 2. Further, the vehicle 2 may include a receiver conforming to another satellite positioning system, instead of the GPS receiver 11.

The GPS receiver 11 receives a GPS signal from a GPS satellite every predetermined period, and determines the location of the vehicle 2, based on the received GPS signal. The GPS receiver 11 then outputs a positioning signal indicating the result of determination of the location of the vehicle 2 on the basis of the GPS signal to the ECU 16 via the in-vehicle network every predetermined period.

The camera 12 is an example of an image capturing unit, and includes a two-dimensional detector constructed from an array of optoelectronic transducers, such as CCD or C-MOS, having sensitivity to visible light and a focusing optical system focusing an image of a target region on the two-dimensional detector. The camera 12 is attached, for example, inside the vehicle 2 so as to direct, for example, the front of the vehicle 2. The camera 12 takes a picture of a region in front of the vehicle 2 every predetermined capturing period (e.g., 1/30 to 1/10 seconds), and generates images in which the region is captured. The images captured by the camera 12 may be color or gray images. The vehicle 2 may include a plurality of cameras taking pictures in different orientations or having different focal lengths.

Every time generating an image, the camera 12 outputs the generated image to the ECU 16 via the in-vehicle network.

The wireless communication terminal 13 is a device to perform wireless communication processing conforming to a predetermined standard of wireless communication, and accesses, for example, the wireless base station 5 to connect to the server 3 via the wireless base station 5 and the communication network 4. The wireless communication terminal 13 includes information received from the ECU 16, such as vehicle location information indicating the current location of the vehicle 2 or selected map information indicating a selected map, in an uplink radio signal, and transmits the radio signal to the wireless base station 5, thereby transmitting the vehicle location information, the selected map information, or the like to the server 3. The wireless communication terminal 13 also receives a downlink radio signal from the wireless base station 5, and passes candidate map information, which indicates identification information on a selectable map (e.g., the name of the map, the name of a related provider, the identification number of the map, etc.), or the map included in the radio signal from the server 3 to the ECU 16.

The user interface 14 includes, for example, a touch panel display and is placed so as to face the driver inside the vehicle 2. The user interface 14 may separately include a display device, such as a liquid crystal display, and an input device including a plurality of operation buttons. The user interface 14 displays, for example, the identification information on a selectable map indicated by the candidate map information received from the ECU 16. The user interface 14 also generates an operation signal in response to an operation by the driver, such as selection of a map, and outputs the generated operation signal to the ECU 16.

The storage device 15 includes, for example, a hard disk drive or a nonvolatile semiconductor memory, and stores a map received from the server 3. Each map includes information on travel conditions of individual roads, such as the location of each predetermined section of the roads and information indicating individual traffic lanes, road markings (e.g., lane division lines or stop lines) and signposts in the section. The storage device 15 reads out a map in response to a request from the ECU 16 to do so, and passes the map to the ECU 16 via the in-vehicle network.

The ECU 16 performs automated driving control of the vehicle 2 in accordance with the map selected by the driver from the plurality of maps which the server 3 can deliver. To this end, the ECU 16 includes, for example, one or more processors, a memory circuit and a communication interface for connecting the ECU 16 to the in-vehicle network. At predetermined timing, the ECU 16 generates the vehicle location information including the current location of the vehicle 2 indicated by the positioning signal received from the GPS receiver 11, and transmits the vehicle location information via the wireless communication terminal 13 to the server 3. The predetermined timing may be, for example, timing when an ignition switch is turned on or timing when the ECU 16 receives a planned travel route from the navigation device. The ECU 16 may include the planned travel route in the vehicle location information. The ECU 16 causes the user interface 14 to display the identification information on a selectable map indicated by the candidate map information received from the server 3 via the wireless communication terminal 13. Upon receiving an operation signal indicating a map selected by a driver's operation from the user interface 14, the ECU 16 generates the selected map information indicating the selected map, and transmits the selected map information via the wireless communication terminal 13 to the server 3. Further, upon receiving a map from the server 3 via the wireless communication terminal 13, the ECU 16 stores the received map in the storage device 15.

Further, the ECU 16 performs automated driving control of the vehicle 2, based on images obtained from the camera 12, a map loaded from the storage device 15 and a planned travel route notified from the navigation device. For example, every time receiving an image from the camera 12, the ECU 16 inputs the received image to a classifier to detect an object near the vehicle 2 in the image. The ECU 16 tracks the detected object by predetermined tracking processing, and generates a planned travel course of the vehicle 2 every predetermined period so that the vehicle 2 may travel along the planned travel route and may not crash into the object being tracked. The planned travel course is represented as, for example, a set of target locations of the vehicle 2 at points in time from the current time to a predetermined time ahead thereof. The ECU 16 may refer to the map and the location of the vehicle 2 to determine a traffic lane on which the vehicle 2 travels. The ECU 16 controls the components of the vehicle 2 so that the vehicle 2 travels along the planned travel course. For example, the ECU 16 determines the acceleration of the vehicle 2 required for the vehicle 2 to travel along the planned travel course, in accordance with the planned travel course and the current speed of the vehicle 2 measured by a vehicle speed sensor (not illustrated), and determines the degree of accelerator opening or the amount of braking so that the acceleration of the vehicle 2 is equal to the determined acceleration. The ECU 16 determines the amount of fuel injection in accordance with the determined degree of accelerator opening, and outputs a control signal depending on the amount of fuel injection to a fuel injector of the engine of the vehicle 2. Alternatively, the ECU 16 outputs a control signal depending on the determined amount of braking to the brake of the vehicle 2.

Further, when the vehicle 2 changes its course in order to travel along the planned travel course, the ECU 16 determines the steering angle of the vehicle 2 in accordance with the planned travel course, and outputs a control signal depending on the steering angle to an actuator (not illustrated) controlling the steering wheel of the vehicle 2.

If the automated driving control of the vehicle 2 cannot continue for some reason, the ECU 16 may generate driving trouble information including a flag indicating that the automated driving control cannot continue, the location where the automated driving control has become impossible to continue, and the identification information on the map used for the automated driving control. The ECU 16 may transmit the generated driving trouble information via the wireless communication terminal 13 to the server 3. Further, the ECU 16 may receive a map different from the map used for the automated driving control from the server 3 via the wireless communication terminal 13 after the automated driving control has become temporarily impossible to continue. If the automated driving control can be restarted by using the newly received map, the ECU 16 may generate driving restart information including a flag indicating that the automated driving control can be restarted and the identification information on the map used at the time of restart of the automated driving control, and transmit the generated driving restart information via the wireless communication terminal 13 to the server 3.

Next, the server 3 will be described.

FIG. 3 illustrates the hardware configuration of the server 3, which is an example of the apparatus for evaluating degrees of contribution. The server 3 includes a communication interface 21, a storage device 22, a memory 23 and a processor 24. The communication interface 21, the storage device 22 and the memory 23 are connected to the processor 24 via a signal line. The server 3 may further include an input device, such as a keyboard and a mouse, and a display device, such as a liquid crystal display.

The communication interface 21 is an example of the communication device, and includes an interface circuit for connecting the server 3 to the communication network 4. The communication interface 21 is configured to be capable of communicating with the vehicle 2 via the communication network 4 and the wireless base station 5. More specifically, the communication interface 21 passes the vehicle location information, the selected map information, the driving trouble information, the driving restart information, or the like received from the vehicle 2 via the wireless base station 5 and the communication network 4 to the processor 24. The communication interface 21 also transmits the candidate map information, a selected map, or the like received from the processor 24 to the vehicle 2 via the communication network 4 and the wireless base station 5.

The storage device 22 is an example of a storage unit, and includes, for example, a hard disk drive, or an optical recording medium and an access device therefor. The storage device 22 stores one or more maps usable for each region (e.g., each country, province or municipal division, or each of predetermined mesh-like divisions), a map management table indicating the identification information on the usable maps for each region, history information indicating the numbers of times of delivery of the respective maps, the algorithm table, the provider table, and the like. The storage device 22 may further store identification information of the vehicle 2. Further, the storage device 22 may store computer programs executed on the processor 24 for performing map delivery processing and contribution evaluating processing. Furthermore, the storage device 22 may store one or more computer programs in which algorithms used for generating or updating the maps and provided by providers are implemented.

The memory 23 is another example of a storage unit, and includes, for example, nonvolatile and volatile semiconductor memories. The memory 23 temporarily stores various types of data generated during execution of the map delivery processing or the contribution evaluating processing, and various types of information, such as the vehicle location information, the selected map information, the driving trouble information or the driving restart information, obtained by communication with the vehicle 2.

The processor 24 is an example of a control unit, and includes one or more central processing units (CPUs) and a peripheral circuit thereof. The processor 24 may further include another arithmetic circuit, such as an arithmetic logic unit or a numeric data processing unit. The processor 24 performs the map delivery processing and the contribution evaluating processing.

FIG. 4 is a functional block diagram of the processor 24, relating to the map delivery processing and the contribution evaluating processing. The processor 24 includes a candidate notifying unit 31, a delivering unit 32, a history updating unit 33, a frequency calculating unit 34 and a contribution calculating unit 35. These units included in the processor 24 are, for example, functional modules implemented by a computer program executed on the processor 24, or may be dedicated arithmetic circuits provided in the processor 24. Out of these units included in the processor 24, the candidate notifying unit 31, the delivering unit 32 and the history updating unit 33 relate to the map delivery processing, while the frequency calculating unit 34 and the contribution calculating unit 35 relate to the contribution evaluating processing.

When the server 3 is notified of the vehicle location information from the vehicle 2, the candidate notifying unit 31 identifies a map usable at the current location of the vehicle 2 indicated by the vehicle location information, and notifies the vehicle 2 of the identification information on the identified map. For example, the candidate notifying unit 31 may refer to the map management table to identify the types of one or more maps usable for a region including the current location of the vehicle 2. When the planned travel route of the vehicle 2 is included in the vehicle location information, the candidate notifying unit 31 may identify a map at least partially overlapping the planned travel route as the map which can be used by the vehicle 2. The candidate notifying unit 31 generates the candidate map information including the identification information on the identified map, and transmits the generated candidate map information to the vehicle 2 via the communication interface 21, the communication network 4 and the wireless base station 5.

When the server 3 is notified of the selected map information from the vehicle 2, the delivering unit 32 loads the selected map indicated by the selected map information from the storage device 22. The delivering unit 32 delivers the loaded map to the vehicle 2 via the communication network 4 and the wireless base station 5. Further, the delivering unit 32 notifies the history updating unit 33 of the identification information on the map delivered to the vehicle 2, the region represented by the map, and the date and time of delivery of the map to the vehicle 2 (hereinafter, simply referred to as the delivery date and time).

When notified of the identification information on the map delivered to the vehicle 2, the region represented by the map, and the delivery date and time from the delivering unit 32, the history updating unit 33 adds the region, the identification information on the delivered map and the delivery date and time to the history information, thereby updating the history information. The history updating unit 33 stores the updated history information in the storage device 22.

The frequency calculating unit 34 calculates the frequencies of use of the respective algorithms used for generating or updating the maps every predetermined period (e.g., every week, every month, every six months or every year) or at predetermined timing (e.g., timing when the total number of delivered maps reaches a predetermined number, or timing designated by an administrator).

In the present embodiment, the frequency calculating unit 34 calculates the frequencies of use of the respective algorithms, based on the numbers of times of delivery of the respective maps and the algorithm table indicating the algorithms used for generating or updating the respective maps. In the following description, the frequency calculating unit 34 will calculate the frequencies of use of the respective algorithms, based on the numbers of times of delivery of maps representing a region of interest. However, the invention is not limited to this particular case; the frequency calculating unit 34 may calculate the frequencies of use of the algorithms without limiting to the maps representing a particular region.

The algorithms used for generating or updating maps include, for example, algorithms each achieving an individual function relating to generation or update of the maps. Alternatively, a single algorithm may achieve a plurality of functions. For example, the algorithms used for generating or updating maps include an algorithm for detecting an object, such as a terrestrial feature near the vehicle, from an image captured by the camera mounted on the vehicle or a sensor signal indicating the environment around the vehicle, such as a ranging signal obtained from a LiDAR sensor mounted on the vehicle. Further, the algorithms used for generating or updating maps may include an algorithm for detecting a location or a terrestrial feature where some change has occurred from a plurality of sensor signals obtained at different timings for each individual location. Furthermore, the algorithms used for generating or updating maps may include an algorithm for reflecting a terrestrial feature or an object detected from the sensor signal in a map, or an algorithm for updating a map, based on the detected terrestrial feature or object.

The frequency calculating unit 34 refers to, for example, the history information relating to the region of interest to count the numbers of times of delivery of the respective maps representing the region of interest in the latest predetermined period. The frequency calculating unit 34 may normalize the numbers of times of delivery of the respective maps by the number of vehicles 2 capable of downloading the maps (hereinafter, referred to as target vehicles). In this case, the frequency calculating unit 34 may identify a vehicle 2 as the target vehicle, based on, for example, whether or not the location of the vehicle 2 indicated by the received vehicle location information is included in the region represented by the map or a surrounding region thereof, or whether or not at least part of the planned travel route determined by the navigation device included in the target vehicle is included in the region represented by the map.

Then, the frequency calculating unit 34 may refer to the algorithm table to identify one or more algorithms in use for each map, and calculate, for each algorithm, the sum of the numbers of times of delivery of the maps for which the algorithm is used, as the frequency of use of the algorithm.

FIG. 5 illustrates an example of the relationship between providers, algorithms and maps for briefly describing the calculation of the frequencies of use and the degrees of contribution according to the present embodiment. For example, as in the relationship 500 illustrated in FIG. 5, suppose that an algorithm 1 provided by a provider α is used for generating or updating maps A and B. Let mA and mB denote the numbers of times of delivery of the maps A and B, respectively (mA and mB are integers of 0 or more); then, the frequency calculating unit 34 calculates the frequency of use of the algorithm 1 as (mA+mB). In addition, for example, suppose that an algorithm 3 provided by a provider β is used for generating or updating maps B, C and D. Let mB, mC and mD denote the numbers of times of delivery of the maps B, C and D, respectively (mB, mC and mD are integers of 0 or more); then, the frequency calculating unit 34 calculates the frequency of use of the algorithm 3 as (mB+mC+mD). Calculating the frequencies of use of the respective algorithms, the frequency calculating unit 34 notifies them to the contribution calculating unit 35.

The contribution calculating unit 35 calculates the degrees of contribution of the respective providers, based on the frequencies of use of the respective algorithms and the provider table indicating the providers of the respective algorithms, every time the frequencies of use of the respective algorithms are notified. At this time, the contribution calculating unit 35 calculates the degree of contribution of each provider so that the degree of contribution increases as the frequency of use of an algorithm provided by the provider increases.

To this end, the contribution calculating unit 35 refers to the provider table to identify the providers of the respective algorithms. Then, for each provider, the contribution calculating unit 35 calculates the sum of the frequencies of use of algorithms provided by the provider, and determines the sum as the degree of contribution of the provider.

With reference to FIG. 5 again, the provider α provides two algorithms (algorithms 1 and 2). The frequency of use of the algorithm 1 is (mA+mB), and that of the algorithm 2 is mA. In this case, the degree of contribution of the provider α is mA+(mA+mB)=(2 mA+mB). In addition, the provider β provides the algorithm 3. The frequency of use of the algorithm 3 is (mB+mC+mD). Accordingly, the degree of contribution of the provider β is (mB+mC+mD). Further, a provider γ provides algorithms 4 and 5. The frequency of use of the algorithm 4 is (mB+mC), and that of the algorithm 5 is mD. Accordingly, the degree of contribution of the provider γ is (mB+mC+mD).

The contribution calculating unit 35 may multiply the sum of the frequencies of use of algorithms provided by a provider by a predetermined factor, or substitute the sum of the frequencies of use into a predetermined equation for calculating a degree of contribution, thereby calculating the degree of contribution of the provider. The contribution calculating unit 35 may assign weighting factors to algorithms in accordance with the functions achieved by the algorithms. In this case, the contribution calculating unit 35 may multiply the frequency of use of each algorithm by the weighting factor of the algorithm to calculate a weighted frequency of use, and calculate, for each provider, the sum of the weighted frequencies of use of algorithms provided by the provider as the degree of contribution of the provider. In this case also, the contribution calculating unit 35 may multiply the sum of the weighted frequencies of use of algorithms provided by a provider by a predetermined factor, or substitute the sum of the weighted frequencies of use into a predetermined equation for calculating a degree of contribution, thereby calculating the degree of contribution of the provider. In this way, the contribution calculating unit 35 can calculate the degrees of contribution of the providers, taking account of how much the functions achieved by the algorithms contribute to generation or update of the maps.

In the case where the vehicle 2 which has downloaded any one of the maps is performing automated driving control on the basis of the downloaded map, when the automated driving control has become impossible to continue, the contribution calculating unit 35 may decrease the degree of contribution of the provider who provides the algorithm used for generating or updating the map. In this case, the contribution calculating unit 35 may refer to, for example, the driving trouble information received from the vehicle 2 to identify the map used when the automated driving control has become impossible to continue. Further, the contribution calculating unit 35 may refer to the driving restart information received from the vehicle 2 to determine whether or not the automated driving control can be restarted by using another map at the location where the automated driving control has become impossible to continue. When the automated driving control is restarted by using another map after the automated driving control has become temporarily impossible to continue, the map used when the automated driving control has become impossible to continue is supposed to have some error (e.g., the location or type of a road marking is incorrect, or a terrestrial feature which should exist is not represented in the map, etc.). Accordingly, the contribution calculating unit 35 subtracts a predetermined point from the degree of contribution of the provider who provides the algorithm used for generating or updating the map used when the automated driving control has become impossible to continue, or multiplies the degree of contribution of the provider by a factor less than one, thereby decreasing the degree of contribution of the provider. In this way, the contribution calculating unit 35 allows the degree of contribution of a provider contributing to generation or update of a more accurate map to be higher.

Further, regarding a particular region, a map used as a reference (hereinafter, simply referred to as a reference map) may be stored in the storage device 22 in advance. The reference map is created, for example, based on an actual result of a land survey of individual roads included in the particular region and terrestrial features on or around the roads. In other words, the locations and types of individual roads and terrestrial features represented in the reference map can be regarded as accurate. In this case, for each of the maps, the contribution calculating unit 35 may compare the location and type of each terrestrial feature represented in the map with those of the corresponding terrestrial feature represented in the reference map. The contribution calculating unit 35 may decrease the degree of contribution of a provider who provides an algorithm used for generating or updating a map as a difference between the location and type of each terrestrial feature represented in the map and those of the corresponding terrestrial feature represented in the reference map increases. For example, the contribution calculating unit 35 decreases the degree of contribution of a provider who provides an algorithm used for generating or updating a map as the number of those terrestrial features represented in the map whose locations are respectively displaced by amounts not less than a predetermined threshold from the locations of the corresponding terrestrial features represented in the reference map increases. Alternatively, the contribution calculating unit 35 may decrease the degree of contribution of a provider who provides an algorithm used for generating or updating a map as the number of those terrestrial features represented in the map whose types are different from the types of the corresponding terrestrial features represented in the reference map increases. Further, the contribution calculating unit 35 may decrease the degree of contribution of a provider who provides an algorithm used for generating or updating a map of interest as the number of those terrestrial features represented in the reference map which are not represented in the map of interest increases. In this way, the contribution calculating unit 35 allows the degree of contribution of a provider contributing to generation or update of a more accurate map to be higher.

The contribution calculating unit 35 may give each provider an incentive point in accordance with the degree of contribution of the provider. The incentive point may represent, for example, economic value or another kind of value. The contribution calculating unit 35 may give, for example, a value obtained by multiplying the degree of contribution of a provider by a predetermined factor as the incentive point of the provider. The contribution calculating unit 35 stores the incentive points of the respective providers in the storage device 22. Further, the server 3 may offer an advantage to a provider in accordance with the incentive point of the provider. The server 3 may cause a map for which an algorithm of a provider is used to be more likely to be selected by a driver of the vehicle 2 as the incentive point of the provider increases.

For example, each map may be assigned a degree of credibility indicating how much the information on travel conditions of individual roads represented in the map is reliable. The contribution calculating unit 35 makes the degree of credibility be a higher value as the degree of contribution of a provider who provides an algorithm used for generating or updating the corresponding map increases, i.e., as the incentive point increases. For example, the contribution calculating unit 35 may use the degree of contribution itself as the degree of credibility, or a value obtained by normalizing the degree of contribution by the range thereof as the degree of credibility. Alternatively, the contribution calculating unit 35 may substitute the degree of contribution or the normalized degree of contribution into a predetermined equation for calculating a degree of credibility to calculate the degree of credibility. When algorithms provided by a plurality of providers are used for generating or updating a single map, the contribution calculating unit 35 may assign the degree of credibility in accordance with an average of the degrees of contribution of the providers who provide the algorithms. The candidate notifying unit 31 may include the degree of credibility of each map in the candidate map information. In this case, when a driver selects a map, the user interface 14 of the vehicle 2 may display the degree of credibility assigned to the map, together with the identification information on the map. This makes a map having a higher degree of credibility be more likely to be selected by a driver.

Further, any one of the maps may be installed on the vehicle 2 in advance as a standard map. In this case, a map generated by an algorithm provided by a provider having the highest degree of contribution may be set as a standard map. This makes a map generated with the help of a provider having the highest degree of contribution be more likely to be selected.

FIG. 6 is an operation flowchart of the contribution evaluating processing in the server 3. The processor 24 of the server 3 may perform the contribution evaluating processing in accordance with the following operation flowchart.

The frequency calculating unit 34 of the processor 24 refers to the history information to count the number of times of delivery of each map in the latest predetermined period (step S101). The frequency calculating unit 34 refers to the number of times of delivery of each map and the algorithm table to calculate the frequency of use of each algorithm (step S102).

The contribution calculating unit 35 of the processor 24 refers to the frequency of use of each algorithm and the provider table to calculate the degree of contribution of each provider (step S103). The contribution calculating unit 35 determines the incentive point of each provider in accordance with the degree of contribution of the provider, and gives the determined incentive point to the provider (step S104). The processor 24 then terminates the contribution evaluating processing.

As has been described above, for each of the algorithms used for generating or updating any one of the plurality of maps, the apparatus for evaluating degrees of contribution determines the frequency of use of the algorithm, based on the numbers of times of delivery of the respective maps. Then, for each of the providers who provide any one of the algorithms, the apparatus calculates the degree of contribution of the provider, based on the frequencies of use of the respective algorithms. As described above, calculating the degrees of contribution of the providers on the basis of the frequencies of use of the provided algorithms, the apparatus can appropriately evaluate the degrees of contribution of the providers.

According to a modified example, each map may have a layered structure. For example, each map may include four layers, i.e., a first layer including static information, a second layer including quasi-static information, a third layer including quasi-dynamic information and a fourth layer including dynamic information. The static information in the first layer includes, for example, information on terrestrial features, such as road markings or signposts, and information on traffic lanes, i.e., information on what does not change basically. Accordingly, the static information in the first layer may be updated on a relatively long cycle (e.g., one month). The quasi-static information in the second layer includes, for example, information on traffic restrictions and road construction, and weather information on a wide area, i.e., information on what is unchanged for a certain period but may be changed in a shorter period than the static information. Accordingly, the quasi-static information in the second layer may be updated on a shorter cycle (e.g., one hour) than the update cycle of the static information in the first layer. Further, the quasi-dynamic information in the third layer includes, for example, information on an accident and a traffic jam, and weather information on a narrow area, i.e., information on what may be changed in a shorter period than the quasi-static information. Accordingly, the quasi-dynamic information in the third layer may be updated on a shorter cycle (e.g., one minute) than the update cycle of the quasi-static information in the second layer. Furthermore, the dynamic information in the fourth layer includes, for example, information on surrounding vehicles and pedestrians, and information on signal lights, i.e., information on what may be changed in real time. Accordingly, the dynamic information in the fourth layer is updated, for example, in real time.

In this way, when each map includes a plurality of layers, the contribution calculating unit 35 may calculate the degrees of contribution of the providers for each layer of the map. In this case, the algorithm table may be configured to indicate not only the maps for which the respective algorithms are used but also the layers in which the respective algorithms are used. The history information may additionally include information indicating the layer of the map delivered from the server 3 to the vehicle 2. In this way, the contribution calculating unit 35 can count the numbers of times of delivery for each layer of the maps, and perform processing similar to that described in the above embodiment, based on the algorithm table and the numbers of times of delivery for each layer, to determine the frequencies of use of the algorithms for each layer of the maps. Accordingly, the contribution calculating unit 35 can perform processing similar to that described in the above embodiment, based on the provider table and the frequencies of use of the algorithms for each layer of the maps, to calculate the degrees of contribution of the providers for each layer of the maps. Further, in this case, the contribution calculating unit 35 may give an incentive point to each provider in accordance with the degree of contribution for each layer of the maps. In this case, the contribution calculating unit 35 may assign weighting factors to the respective layers of the maps, and multiply the degrees of contribution of each layer by the weighting factor of the layer to calculate weighted degrees of contribution, and determine the incentive point to be given in accordance with the sum of the weighted degrees of contribution for each layer.

As described above, those skilled in the art may make various modifications according to embodiments within the scope of the present invention.

What is claimed is:

1. An apparatus for evaluating degrees of contribution, comprising:
a memory configured to store a plurality of maps including information on travel conditions of individual roads, an algorithm table indicating, for each of the plurality of maps, an algorithm used for generating or updating the map out of a plurality of algorithms each used for generating or updating at least any one of the plurality of maps, and a provider table indicating, for each of the plurality of algorithms, a provider who provides the algorithm out of a plurality of providers; and
a processor configured to
determine frequencies of use of the plurality of algorithms, based on the algorithm table and the numbers of times of delivery of the plurality of maps in a predetermined period, and
calculate a degree of contribution to generation or update of a map for each of the plurality of providers, based on the provider table and the frequencies of use of the plurality of algorithms.

2. The apparatus according to claim 1, wherein the processor assigns weights to the frequencies of use of the plurality of algorithms in accordance with types of the plurality of algorithms, and calculates the degree of contribution for each of the plurality of providers in accordance with the sum of weighted frequencies of use of algorithms provided by the provider.

3. The apparatus according to claim 1, wherein for each of the plurality of providers, the processor gives a higher incentive point to the provider as the degree of contribution of the provider increases.

4. The apparatus according to claim 1, wherein
each of the plurality of maps is assigned a degree of credibility of information on the travel conditions represented in the map, and
for each of the plurality of maps, the processor assigns a higher degree of credibility to the map as the degree of contribution of a provider of an algorithm used for generating or updating the map increases.

5. The apparatus according to claim 1, further comprising a communication device capable of communicating with a vehicle using any one of the plurality of maps to perform automated driving control, wherein
upon receiving information indicating that automated driving control cannot continue and information indicating a map in use out of the plurality of maps from the vehicle via the communication device, the processor decreases the degree of contribution of a provider who provides an algorithm used for generating or updating the map out of the plurality of algorithms.

6. The apparatus according to claim 1, wherein
each of the plurality of maps represents the locations and types of terrestrial features imposing travel conditions of individual roads, and the memory further stores a reference map representing the locations and types of the terrestrial features, and
the processor decreases the degree of contribution of a provider who provides an algorithm used for generating or updating any one of the plurality of maps out of the plurality of algorithms as a difference between the location and type of a terrestrial feature represented in the map and the location and type of a corresponding terrestrial feature represented in the reference map increases.
